(19) United States
(12) Patent Application Publication
(10) Pub. No.: US 2023/0188302 A1
(43) Pub. Date: Jun. 15, 2023

(54) CONFIGURABLE METRICS FOR CHANNEL STATE COMPRESSION AND FEEDBACK

(71) Applicant: QUALCOMM INCORPORATED, San Diego, CA (US)

(72) Inventors: Pavan Kumar VITTHALADEVUNI, San Diego, CA (US); Taesang YOO, San Diego, CA (US); Naga BHUSHAN, San Diego, CA (US); June NAMGOONG, San Diego, CA (US); Bo CHEN, Beijing (CN); Ruifeng MA, Beijing (CN); Krishna Kiran MUKKAVILLI, San Diego, CA (US); Tingfang JI, San Diego, CA (US)

(21) Appl. No.: 18/004,286

(22) PCT Filed: Aug. 31, 2020
(86) PCT No.: PCT/CN2020/112476

§ 371 Date: Jan. 4, 2023

(51) Int. Cl. H04L 5/00; H04W 72/231; G06N 3/08

(52) U.S. Cl. CPC H04L 5/0057; H04L 5/0048; H04W 72/231; G06N 3/08

(57) ABSTRACT

Methods, systems, and devices for wireless communications are described. Generally, the described techniques at a user equipment (UE) provide for efficiently reporting channel state information (CSI) to a base station with an appropriate level of accuracy. In particular, the base station may indicate a level of accuracy to the UE for reporting CSI. The UE may encode the CSI using a first neural network, and the base station may decode the CSI using a second neural network. The first and second neural networks may form a neural network pair, and the UE may train the neural network pair based on the level of accuracy indicated by the base station. For example, the base station may indicate a loss function corresponding to a level of accuracy with which CSI is to be reported by the UE, and the UE may train the neural network pair using the loss function.

### CROSS REFERENCE

The present Application is a 371 national stage filing of International PCT Application No. PCT/CN2020/112476 by VITTHALADEVUNI et al. entitled “CONFIGURABLE METRICS FOR CHANNEL STATE COMPRESSION AND FEEDBACK,” filed Aug. 31, 2020, which is assigned to the assignee hereof, and which is expressly incorporated by reference in its entirety herein.

### FIELD OF TECHNOLOGY

The following relates generally to wireless communications and more specifically to configurable metrics for channel state compression and feedback.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long-Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM).

A wireless multiple-access communications system may include one or more base stations or one or more network access nodes, each simultaneously supporting communication for multiple communication devices, which may be otherwise known as user equipment (UE). In some wireless communications systems, a UE may be configured to report channel state information (CSI) to a base station to indicate downlink channel conditions, and the base station may use the CSI to improve the quality of downlink transmissions to the UE. For example, the CSI may include a channel quality indicator (CQI), and the base station may use the CQI to identify appropriate parameters (e.g., a modulation and coding scheme (MCS)) for transmitting downlink data to the UE.

### SUMMARY

The described techniques relate to improved methods, systems, devices, and apparatuses that support configurable metrics for channel state compression and feedback. Generally, the described techniques at a user equipment (UE) provide for efficiently reporting channel state information (CSI) to a base station with an appropriate level of accuracy. In particular, the base station may indicate a level of accuracy to the UE for reporting CSI. The UE may encode the CSI using a first neural network, and the base station may decode the CSI using a second neural network. The first and second neural networks may form a neural network pair, and the UE may train the neural network pair based on a level of accuracy indicated by the base station. For example, the base station may indicate a loss metric or function corresponding to a level of accuracy with which CSI is to be reported by the UE, and the UE may train the neural network pair using the loss metric or function. Using these techniques, the base station may be able to configure the UE to report CSI with an appropriate level of accuracy.

A method of wireless communication at a UE is described. The method may include receiving, from a base station, an indication of a level of accuracy for reporting channel state feedback to the base station, receiving downlink data or reference signals from the base station, and reporting the channel state feedback to the base station corresponding to the indicated level of accuracy based on the downlink data or the reference signals.

An apparatus for wireless communication at a UE is described. The apparatus may include a processor, memory coupled with the processor, and instructions stored in the memory. The instructions may be executable by the processor to cause the apparatus to receive, from a base station, an indication of a level of accuracy for reporting channel state feedback to the base station, receive downlink data or reference signals from the base station, and report the channel state feedback to the base station corresponding to the indicated level of accuracy based on the downlink data or the reference signals.

Another apparatus for wireless communication at a UE is described. The apparatus may include means for receiving, from a base station, an indication of a level of accuracy for reporting channel state feedback to the base station, receiving downlink data or reference signals from the base station, and reporting the channel state feedback to the base station corresponding to the indicated level of accuracy based on the downlink data or the reference signals.

A non-transitory computer-readable medium storing code for wireless communication at a UE is described. The code may include instructions executable by a processor to receive, from a base station, an indication of a level of accuracy for reporting channel state feedback to the base station, receive downlink data or reference signals from the base station, and report the channel state feedback to the base station corresponding to the indicated level of accuracy based on the downlink data or the reference signals.

In some examples of the method, apparatuses, and non-transitory computer-readable medium described herein, receiving the indication of the level of accuracy for reporting channel state feedback may include operations, features, means, or instructions for receiving an indication of a loss function corresponding to the level of accuracy for training a neural network pair, the neural network pair including a first neural network at an encoder for encoding the channel state feedback and a second neural network at a decoder for decoding the channel state feedback, the method further including training the neural network pair using the loss function. Because the UE may receive the indication of the loss function from the base station, the UE may report CSI feedback to the base station at an appropriate level of accuracy.

In some examples of the method, apparatuses, and non-transitory computer-readable medium described herein, training the neural network pair using the loss function may include operations, features, means, or instructions for iteratively entering channel state feedback input into the neural network pair and identifying channel state feedback output from the neural network pair, determining a difference between the channel state feedback input and the channel state feedback output for each iteration using the loss function, where the difference includes a loss, and adjusting coefficients of the neural network pair for each iteration to minimize the difference between the channel state feedback input and the channel state feedback output based on the determining. Because the UE may train the neural network pair using a loss function corresponding to the indicated level of accuracy, the UE may report the CSI feedback at an appropriate level of accuracy to minimize unnecessary overhead.

In some examples of the method, apparatuses, and non-transitory computer-readable medium described herein, reporting the channel state feedback corresponding to the indicated level of accuracy may include operations, features, means, or instructions for encoding the channel state feedback using the first neural network at the encoder based on the training, and reporting the encoded channel state feedback. Some examples of the method, apparatuses, and non-transitory computer-readable medium described herein may further include operations, features, means, or instructions for sending, to the base station, coefficients of the second neural network for decoding the channel state feedback based on the training. Because the UE may send coefficients of the second neural network for decoding the channel state feedback to the base station, the UE may train the neural network pair without exchanging signaling with the base station resulting in reduced overhead.

Some examples of the method, apparatuses, and non-transitory computer-readable medium described herein may further include operations, features, means, or instructions for receiving, from the base station, an indication to train a set of neural network pairs based on a set of levels of accuracy, the set of neural network pairs including the neural network pair, and training each of the set of neural network pairs based on a respective level of accuracy of the set of levels of accuracy. In some examples of the method, apparatuses, and non-transitory computer-readable medium described herein, receiving the indication of the level of accuracy may include operations, features, means, or instructions for receiving an indication to use the neural network pair of the set of neural network pairs for reporting the channel state feedback. Because the UE may train a set of neural network pairs, the base station may dynamically indicate a level of accuracy to the UE, and the UE may select one of the set of neural network pairs corresponding to the level of accuracy to use to encode the channel state feedback. That is, the UE may avoid training a neural network pair based on an indicated level of accuracy after receiving the indication of the level of accuracy, resulting in reduced latency.

Some examples of the method, apparatuses, and non-transitory computer-readable medium described herein may further include operations, features, means, or instructions for autonomously selecting the neural network pair of the set of neural network pairs for reporting the channel state feedback. Some examples of the method, apparatuses, and non-transitory computer-readable medium described herein may further include operations, features, means, or instructions for receiving an indication of a subset of the set of neural network pairs for the UE to train. Some examples of the method, apparatuses, and non-transitory computer-readable medium described herein may further include operations, features, means, or instructions for receiving data from the base station on the subband or spatial layer or in accordance with the channel tap based on reporting the channel state feedback corresponding to the indicated level of accuracy. Using these techniques, the base station may adapt a level of accuracy with which the UE is to report CSI feedback based on one or more configurations with which the base station is to transmit data to the UE.

Some examples of the method, apparatuses, and non-transitory computer-readable medium described herein may further include operations, features, means, or instructions for receiving a retransmission of the same data that the UE failed to decode based on reporting the channel state feedback corresponding to the indicated level of accuracy. Some examples of the method, apparatuses, and non-transitory computer-readable medium described herein may further include operations, features, means, or instructions for identifying a number of bits for reporting the channel state feedback based on the level of accuracy, where the number of bits may be directly related to the level of accuracy, and reporting the channel state feedback corresponding to the indicated level of accuracy with the identified number of bits.

Some examples of the method, apparatuses, and non-transitory computer-readable medium described herein may further include operations, features, means, or instructions for receiving an indication of the number of bits for reporting the channel state feedback based on the level of accuracy. In some examples of the method, apparatuses, and non-transitory computer-readable medium described herein, receiving the indication of the level of accuracy may include operations, features, means, or instructions for receiving the indication of the level of accuracy in radio resource control (RRC) signaling or in a MAC control element (MAC-CE). Because the UE may identify or select a number of bits for reporting channel state feedback based on the level of accuracy, the overhead of reporting the channel state feedback may be minimized when appropriate.

A method of wireless communication at a base station is described. The method may include transmitting, to a UE, an indication of a level of accuracy for reporting channel state feedback to the base station, transmitting downlink data or reference signals to the UE, and receiving channel state feedback from the UE corresponding to the indicated level of accuracy based on transmitting the downlink data or reference signals to the UE.

An apparatus for wireless communication at a base station is described. The apparatus may include a processor, memory coupled with the processor, and instructions stored in the memory. The instructions may be executable by the processor to cause the apparatus to transmit, to a UE, an indication of a level of accuracy for reporting channel state feedback to the base station, transmit downlink data or reference signals to the UE, and receive channel state feedback from the UE corresponding to the indicated level of accuracy based on transmitting the downlink data or reference signals to the UE.

Another apparatus for wireless communication at a base station is described. The apparatus may include means for transmitting, to a UE, an indication of a level of accuracy for reporting channel state feedback to the base station, transmitting downlink data or reference signals to the UE, and receiving channel state feedback from the UE corresponding to the indicated level of accuracy based on transmitting the downlink data or reference signals to the UE.

A non-transitory computer-readable medium storing code for wireless communication at a base station is described. The code may include instructions executable by a processor to transmit, to a UE, an indication of a level of accuracy for reporting channel state feedback to the base station, transmit downlink data or reference signals to the UE, and receive channel state feedback from the UE corresponding to the indicated level of accuracy based on transmitting the downlink data or reference signals to the UE.

In some examples of the method, apparatuses, and non-transitory computer-readable medium described herein, transmitting the indication of the level of accuracy for reporting channel state feedback may include operations, features, means, or instructions for transmitting an indication of a loss function for the UE to use to train a neural network pair for reporting the channel state feedback. Some examples of the method, apparatuses, and non-transitory computer-readable medium described herein may further include operations, features, means, or instructions for receiving, from the UE, coefficients of a neural network at a decoder for decoding the channel state feedback from the UE, and decoding the channel state feedback from the UE using the neural network at the decoder.

Some examples of the method, apparatuses, and non-transitory computer-readable medium described herein may further include operations, features, means, or instructions for transmitting an indication for the UE to train a set of neural network pairs based on a set of levels of accuracy, each neural network pair including a first neural network at an encoder for encoding the channel state feedback and a second neural network at a decoder for decoding the channel state feedback. In some examples of the method, apparatuses, and non-transitory computer-readable medium described herein, transmitting the indication of the level of accuracy may include operations, features, means, or instructions for transmitting an indication for the UE to use a neural network pair of the set of neural network pairs for reporting the channel state feedback.

Some examples of the method, apparatuses, and non-transitory computer-readable medium described herein may further include operations, features, means, or instructions for transmitting an indication of a subset of the set of neural network pairs for the UE to train. In some examples of the method, apparatuses, and non-transitory computer-readable medium described herein, transmitting the indication of the level of accuracy for reporting channel state feedback may include operations, features, means, or instructions for transmitting indications of different levels of accuracy for reporting channel state feedback for different subbands, spatial layers, channel taps, or in response to failing to decode different numbers of downlink transmissions including same data. In some examples of the method, apparatuses, and non-transitory computer-readable medium described herein, the indicated level of accuracy may include operations, features, means, or instructions for transmitting an indication of a second level of accuracy for reporting channel state feedback to be used to schedule a second downlink transmission, the first level of accuracy being different from the second level of accuracy.

Some examples of the method, apparatuses, and non-transitory computer-readable medium described herein may further include operations, features, means, or instructions for transmitting an indication of a number of bits for the UE to use to report the channel state feedback based on the level of accuracy, where the number of bits may be directly related to the level of accuracy, and receiving the channel state feedback corresponding to the indicated level of accuracy with the identified number of bits. In some examples of the method, apparatuses, and non-transitory computer-readable medium described herein, transmitting the indication of the level of accuracy may include operations, features, means, or instructions for transmitting the indication of the level of accuracy in RRC signaling or in a MAC-CE.

### BRIEF DESCRIPTION OF THE DRAWINGS

FIG. 1 illustrates an example of a wireless communications system that supports configurable metrics for channel state compression and feedback in accordance with aspects of the present disclosure.

FIG. 2 illustrates an example of CSI feedback encoded by an encoder using a first neural network and decoded by a decoder using a second neural network in accordance with aspects of the present disclosure.

FIG. 3 illustrates an example of a wireless communications system that supports configurable metrics for channel state compression and feedback in accordance with aspects of the present disclosure.

FIG. 4 illustrates an example of a process flow that supports configurable metrics for channel state compression and feedback in accordance with aspects of the present disclosure.

FIGS. 5 and 6 show block diagrams of devices that support configurable metrics for channel state compression and feedback in accordance with aspects of the present disclosure.

FIG. 7 shows a block diagram of a communications manager that supports configurable metrics for channel state compression and feedback in accordance with aspects of the present disclosure.

FIG. 8 shows a diagram of a system including a device that supports configurable metrics for channel state compression and feedback in accordance with aspects of the present disclosure.

FIGS. 9 and 10 show block diagrams of devices that support configurable metrics for channel state compression and feedback in accordance with aspects of the present disclosure.

FIG. 11 shows a block diagram of a communications manager that supports configurable metrics for channel state compression and feedback in accordance with aspects of the present disclosure.

FIG. 12 shows a diagram of a system including a device that supports configurable metrics for channel state compression and feedback in accordance with aspects of the present disclosure.

FIGS. 13 and 14 show flowcharts illustrating methods that support configurable metrics for channel state compression and feedback in accordance with aspects of the present disclosure.

### DETAILED DESCRIPTION

In some wireless communications systems, a user equipment (UE) may be configured to perform channel measurements on downlink signals received from a base station and report the channel measurements to the base station. The UE may report the channel measurements as channel state information (CSI) feedback. Using the CSI feedback, the base station may identify suitable parameters for downlink transmissions to the UE to improve the likelihood that the downlink transmissions are received by the UE. The UE may encode the CSI using a first neural network and the base station may decode the CSI using a second neural network. The first and second neural networks may form a neural network pair, and the UE may train the neural network pair based on a level of accuracy (e.g., using a certain loss metric or function). In some cases, however, the UE 115 may be configured to train the neural network pair based on the same level of accuracy for all CSI feedback, and it may be inefficient to transmit all CSI feedback with the same level of accuracy. For instance, if the level of accuracy of reported CSI feedback is unnecessarily high, the overhead of reporting the CSI may also be unnecessarily high. Alternatively, if the level of accuracy or reported CSI feedback is too low, a downlink transmission scheduled using the CSI feedback may be unreliable.

As described herein, a wireless communications system may support efficient techniques that may allow a UE to report CSI to a base station at an appropriate level of accuracy. In particular, the UE may be configured to train a neural network pair (e.g., including a first neural network at an encoder and a second neural network at a decoder) based on a level of accuracy indicated by the base station. For instance, the base station may indicate a loss metric or function corresponding to the level of accuracy with which the CSI is to be reported by the UE, and the UE may train the neural network pair using the loss metric or function. As such, the UE may report the CSI at the level of accuracy indicated by the base station. The indicated level of accuracy may depend on how the base station intends to use the CSI. For example, the base station may indicate different levels of accuracy for CSI associated with different subbands, channel taps, spatial streams, feedback instances, etc. (e.g., such that latency-sensitive and reliability-sensitive transmissions are scheduled based on highly accurate CSI feedback). Accordingly, when a higher level of accuracy is appropriate, the UE may report CSI with the higher level of accuracy. Otherwise, the UE may report CSI with a lower level of accuracy.

Aspects of the disclosure introduced above are described below in the context of a wireless communications system. Examples of processes and signaling exchanges that support configurable metrics for channel state compression and feedback are then described. Aspects of the disclosure are further illustrated by and described with reference to apparatus diagrams, system diagrams, and flowcharts that relate to configurable metrics for channel state compression and feedback.

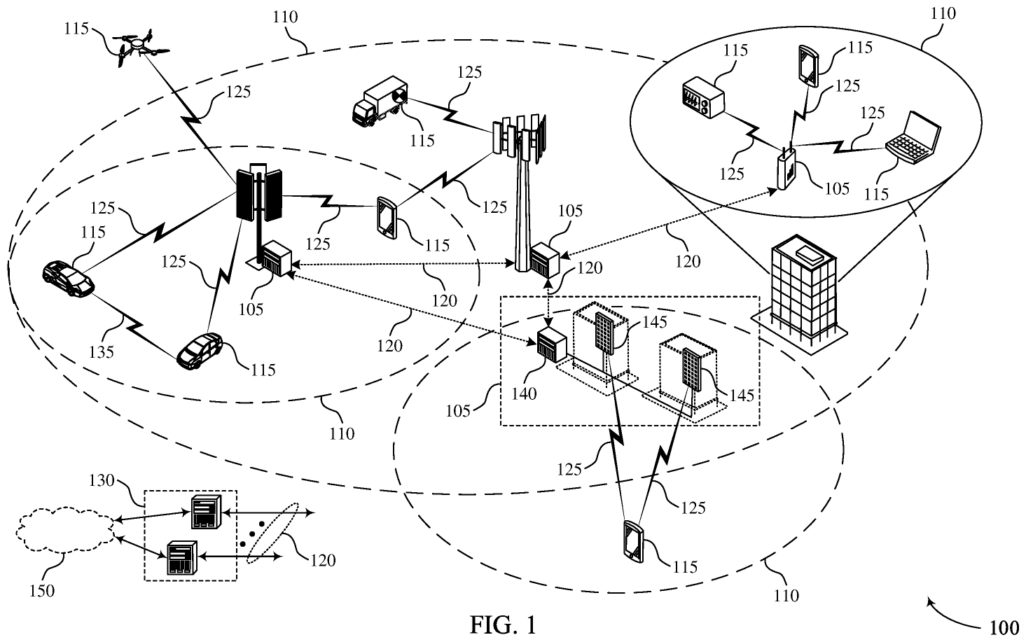

FIG. 1 illustrates an example of a wireless communications system 100 that supports configurable metrics for channel state compression and feedback in accordance with aspects of the present disclosure. The wireless communications system 100 may include one or more base stations 105, one or more UEs 115, and a core network 130. In some examples, the wireless communications system 100 may be a Long-Term Evolution (LTE) network, an LTE-Advanced (LTE-A) network, an LTE-A Pro network, or a New Radio (NR) network. In some examples, the wireless communications system 100 may support mobile broadband (MBB) communications, enhanced MBB (eMBB) communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to the network operators IP services 150. The operators IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In wireless communications system 100, a UE 115 may be configured to perform channel measurements on downlink signals received from a base station 105 and report the channel measurements to the base station 105. The UE 115 may report the channel measurements as CSI feedback. Using the CSI feedback, the base station 105 may identify suitable parameters for downlink transmissions to the UE 115 to improve the likelihood that the downlink transmissions are received by the UE 115. In some cases, the UE 115 may encode the CSI using a first neural network, and the base station 105 may decode the CSI using a second neural network, where the first and second neural networks form a neural network pair.

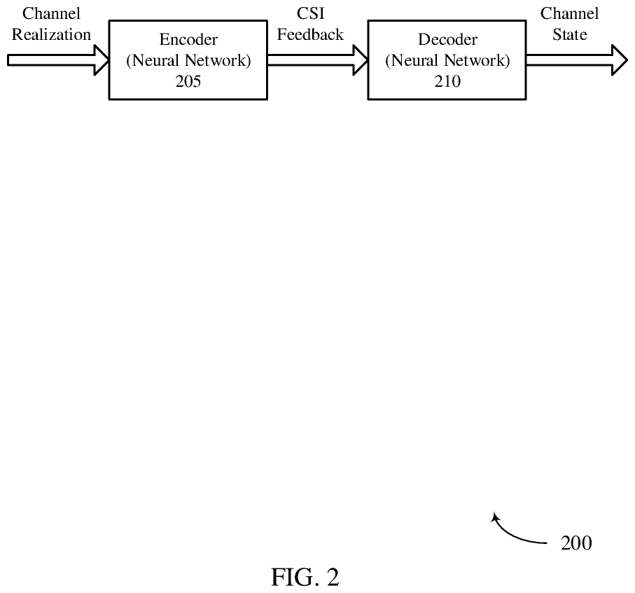

FIG. 2 illustrates an example of CSI feedback 200 encoded by an encoder 205 using a first neural network and decoded by a decoder 210 using a second neural network in accordance with aspects of the present disclosure. In the example of FIG. 2, a UE 115 may input channel realization information into the encoder 205, and the encoder 205 may encode the channel realization information using the first neural network to generate CSI feedback. The channel realization information may refer to the raw channel and may correspond to measurements performed on CSI reference signals (CSI-RSs) received on the channel. Thus, the encoder may take the raw channel as input, and the UE 115 may use the encoder neural network to create and feedback CSI. The UE 115 may transmit the CSI feedback to the base station 105, and the base station 105 may input the CSI feedback into the decoder 210. The decoder 210 may decode the CSI feedback using the second neural network to obtain the channel state (e.g., the base station 105 may use the decoder neural network to recover the raw channel state from the CSI feedback). The base station 105 may then use the channel state to identify suitable parameters for downlink transmissions to the UE 115.

In some wireless communications systems, a UE 115 may train a neural network pair including a first neural network at an encoder and a second neural network at a decoder based on a fixed level of accuracy. Training the neural networks may involve unsupervised learning, supervised learning, or a combination of both. For example, the UE 115 may train the encoder 205 according to one or more machine learning algorithms in a neural network. The neural networks at the encoder 205, the decoder 210, or both may include any number of machine learning layers (e.g., convolution layers, fully connected layers, or some combination thereof). The UE 115 may implement any machine learning techniques to train the neural networks at the encoder 205, the decoder 210, or both. For example, the UE 115 may implement deep learning (e.g., using a deep recurrent network), backpropagation, linear regression, a K-means model, a random forest model, or any combination of these or other machine learning techniques to train one or both of the neural networks.

In some machine learning examples, the network may train a machine learning model on a set of training data. The training data may be a subset of a larger dataset. In some cases, the training may involve determining one or more target features in the dataset. Subsequently, the model may learn the one or more features from the training data (e.g., based on linear regression techniques, such as a linear regression algorithm) and evaluation metrics, such as mean square error (MSE), precision, accuracy, and recall. In some cases, the evaluation metrics may be calculated according to a loss function.

The neural network training may be iterative, such that the UE 115 trains a neural network based on a current version of the neural network and measurements attained since the current version of the neural network was implemented (e.g., rather than starting training from scratch using a full set of historical measurements). Such an iterative training process may reduce the processing overhead associated with training the neural networks and may reduce the amount of historical measurement information that the UE 115 stores for the neural network training. During the training process, the UE may apply the layers to the measurement input, or channel realization, to compress the data from the one or more base stations, sensors, radio access technologies (RATs), etc. The UE may feed the compressed data back through the decoder 210 to determine a number of decoding coefficients or parameters for the decoder neural network.

During training, the UE 115 may update encoder weights, encoder layers, decoder weights, decoder layers, or some combination thereof based on feedback information. For example, the UE 115 may update the encoder weights based on a performance metric for the encoding. Such a performance metric may be a metric measuring the level of compression achieved by the encoder neural network (e.g., comparing the number of bits associated with the encoded CSI feedback to the number of bits associated with the input measurements, or channel realization), a metric measuring the reliability of extracting the input measurements from the encoder output using the decoder neural network, a metric measuring the computational complexity involved in the compression, a metric measuring the system performance based on the encoder neural network, or some combination thereof. Similarly, the UE may update the decoder weights based on a performance metric for the decoding. Such a performance metric may be a metric measuring the similarity between the output measurements and the input measurements, a metric measuring the computational complexity involved in the decompression, a metric measuring the system performance based on the encoder output, or some combination thereof.

In some cases, the UE 115 may be configured with a fixed loss metric or loss function for training the encoder and decoder neural network pair. However, a desired loss metric or loss function for training an encoder and decoder neural network pair for reporting CSI feedback to a base station 105 may depend on how the base station 105 intends on using the CSI feedback. As an example, for single user MIMO (SU-MIMO), a base station 105 may mostly be concerned about learning precoding directions, whereas for multi-user MIMO (MU-MIMO), the base station 105 may be concerned about learning the raw channel state. Further, a desired feedback accuracy may be different on different subbands or on different feedback instances (e.g., for eMBB communications versus URLLC or for MU-MIMO on certain subbands versus on other subbands). Thus, it may be inefficient for a UE 115 to transmit all CSI feedback with the same level of accuracy.

Wireless communications system 100 may support efficient techniques that may allow a UE 115 to report CSI to a base station at an appropriate (e.g., dynamically changing or configurable) level of accuracy. For instance, the UE 115 may receive an indication of a loss function or loss metric corresponding to a level of accuracy, and the UE 115 may use the loss function or loss metric to compute loss when training an encoder and decoder neural network pair. The loss function may be a function used to compute the loss (e.g., a measure of the difference between the input to the neural network pair and the output from the neural network pair), and the loss metric may correspond to a metric used in a loss function. Based on the loss computed in one iteration of training, the UE 115 may adjust coefficients in the neural network pair to minimize the loss computed in future iterations of training. For example, the neural network pair may implement activation functions for each layer of the network (e.g., for hidden layers between the input layer and the output layer). The neural network pair may also implement a loss function, or cost function, based on the difference between an actual value and a predicted value. For each layer of the neural network pair, the cost function may be used to adjust the weights for the next input based on a loss metric. In some examples, the cost function, or loss function, may implement an MSE function, which may calculate the square of the difference between the actual value and the predicted value. Thus, the loss function and the loss metric may be different from the loss. Further, the loss function may be used to minimize the difference between the input and output of a neural network pair or the difference between an aspect of the input and output of the neural network pair.

Because the loss function may correspond to a level of accuracy, any neural network pair trained using the loss function may encode and decode CSI feedback at the corresponding level of accuracy. Thus, reporting CSI feedback corresponding to the level of accuracy may refer to reporting CSI feedback encoded and decoded using the neural network pair trained using the loss function corresponding to the level of accuracy. In some cases, a UE 115 may also be configured to train a plurality of neural network pairs using a plurality of loss functions each corresponding to a level of accuracy. In such cases, the UE 115 may receive an indication of which of the plurality of neural network pairs the UE 115 is to use for reporting CSI. The indication of the neural network pair may correspond to an indication of a level of accuracy since the neural network pair may be trained using a loss function corresponding to the level of accuracy. Thus, reporting CSI feedback corresponding to the level of accuracy may refer to reporting CSI feedback encoded and decoded using the neural network pair of the plurality of neural network pairs trained using the loss function corresponding to the level of accuracy.

Further, because the UE 115 may train both the neural network at an encoder and a neural network at a decoder (e.g., the encoder and decoder may be at the UE 115, and the decoder may also be at a base station 105), the UE 115 may send coefficients of the decoder neural network to a base station 105. Accordingly, the signaling between the UE 115 and a base station 105 may be minimized since the UE 115 may not have to receive the output of the decoder from the base station 105 (e.g., for each iteration of training). The UE 115 may send the coefficients of the decoder neural network to the base station 105 once the UE 115 is finished training the neural network pair. The UE 115 may then encode CSI feedback using the encoder and report the CSI feedback to the base station 105, and the base station 105 may decode the CSI feedback using the decoder based on the coefficients received from the UE 115. Using the techniques described herein, a UE 115 may be able to report CSI at an appropriate level of accuracy to minimize unnecessary overhead while allowing a base station 105 to identify suitable parameters for communications with the UE 115.

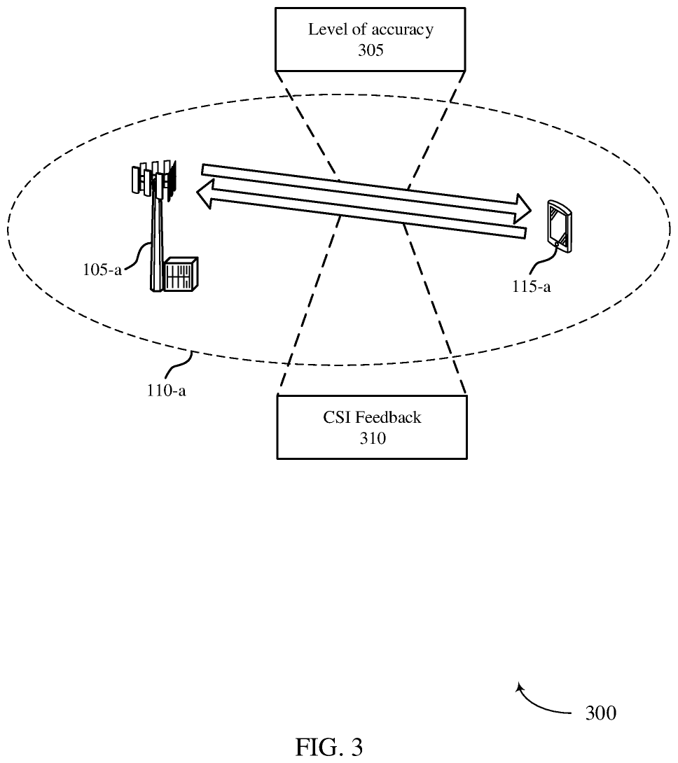

FIG. 3 illustrates an example of a wireless communications system 300 that supports configurable metrics for channel state compression and feedback in accordance with aspects of the present disclosure. The wireless communications system 300 includes a UE 115-a, which may be an example of a UE 115 described with reference to FIGS. 1 and 2. The wireless communications system 300 also includes a base station 105-a, which may be an example of a base station 105 described with reference to FIGS. 1 and 2. The base station 105-a may provide communication coverage for a coverage area 110-a. The wireless communications system 300 may implement aspects of wireless communications system 100. For example, the wireless communications system 300 may support efficient techniques that may allow the UE 115-a to report CSI to the base station 105-a at an appropriate level of accuracy.

In the example of FIG. 3, the base station 105-a may transmit an indication of a level of accuracy 305 with which the UE 115-a is to report CSI feedback 310 to the base station 105-a, and the UE 115-a may report the CSI feedback 310 to the base station 105-a based on the indicated level of accuracy 305. For example, the base station 105-a may transmit an indication of a loss function to the UE 115-a, and the UE 115-a may train an encoder and decoder neural network pair for encoding and decoding the CSI feedback 310 using the loss function. That is, the base station 105-a may configure the UE 115-a to use a specific loss function for encoder and decoder neural network training for reporting the CSI feedback 310. The UE 115-a may train the encoder and decoder neural network pair using real data (e.g., CSI based on actual channel measurements) or other data (e.g., provided by the base station 105-a). To train the neural network pair, the UE 115-a may input CSI into the neural network pair, and the UE 115-a may compare the CSI output from the neural network pair to the CSI input into the neural network pair. The UE 115-a may then adjust coefficients (e.g., weights) in the neural network pair to minimize loss (e.g., minimize the difference between the CSI input into the neural network pair and the CSI output from the neural network pair).

Because the level of accuracy 305 or the loss function may be configured by the base station 105-a, the accuracy of the CSI feedback 310 reported by the UE 115-a may be aligned with the intentions of the base station 105-a. For example, the base station 105-a may configure the UE 115-a to report more accurate (e.g., highly accurate) CSI feedback 310 for latency-sensitive or reliability-sensitive communications, and the base station 105-a may configure the UE 115-a to report less accurate CSI feedback 310 for other communications. In some cases, different levels of accuracy or loss functions may be configured on different subbands, channel taps, spatial streams, or feedback instances. In particular, the base station 105-a may configure different levels of accuracy (e.g., different (relative) accuracy targets or different (relative) weighting for a loss function) over different subbands, channel taps, spatial streams, and feedback instances. The different subbands may be used for different types of communications (e.g., eMBB communications and URLLC), the different channel taps may be compressed to different degrees of accuracy if the UE 115-a is operating on the time-domain channel, the different spatial streams may correspond to transmissions on different beams (e.g., higher accuracy or higher weighting on the strongest beam direction), and the different feedback instances may correspond to different rounds of feedback (e.g., a first round of feedback for URLLC and a second round of feedback for URLLC).

The base station 105-a may transmit the indication of the level of accuracy 305 via a higher layer message (e.g., RRC signaling) or dynamic signaling (e.g., in a MAC control element (MAC-CE)). Further, in some cases, if quantization is being performed on the CSI feedback 310 prior to transmission to the base station 105-a, some paths, subbands, channel taps, spatial streams, feedback instances, etc. may be compressed using a greater number of bits. For example, the UE 115-a may transmit the CSI feedback 310 using a different number of bits depending on the level of accuracy 305 indicated by the base station 105-a. In such cases, the base station 105-a may transmit an indication of the number of bits for the UE 115-a to use to transmit the CSI feedback 310, and the UE 115-a may transmit the CSI feedback 310 with the indicated number of bits.

The base station 105-a may also request that the UE 115-a train multiple encoder and decoder neural network pairs (e.g., N neural network pairs), and the base station 105-a may configure a level of accuracy for each of the neural network pairs (e.g., for a tradeoff between feedback accuracy and CSI feedback overhead). The base station 105-a may then transmit an indication of one of the multiple neural network pairs for the UE 115-a to use to report CSI the feedback 310. Alternatively, the UE 115-a may autonomously select (e.g., without signaling from the base station 105-a) one of the multiple neural network pairs to use to report the CSI feedback 310. In some cases, instead of transmitting an indication of the loss metric or loss function for training a neural network pair, the base station 105-a may transmit an indication of an equation for training the neural network pair. In other cases, the base station 105-a may transmit an indication of a set of loss metrics or loss functions for training neural network pairs. In such cases, the base station 105-a may transmit an indication to the UE 115-a of a loss metric or loss function from the set for the UE to use to train a neural network pair. Alternatively, the UE 115-a may autonomously select a loss metric or loss function from the set to use to train a neural network pair (e.g., based on an indicated level of accuracy).

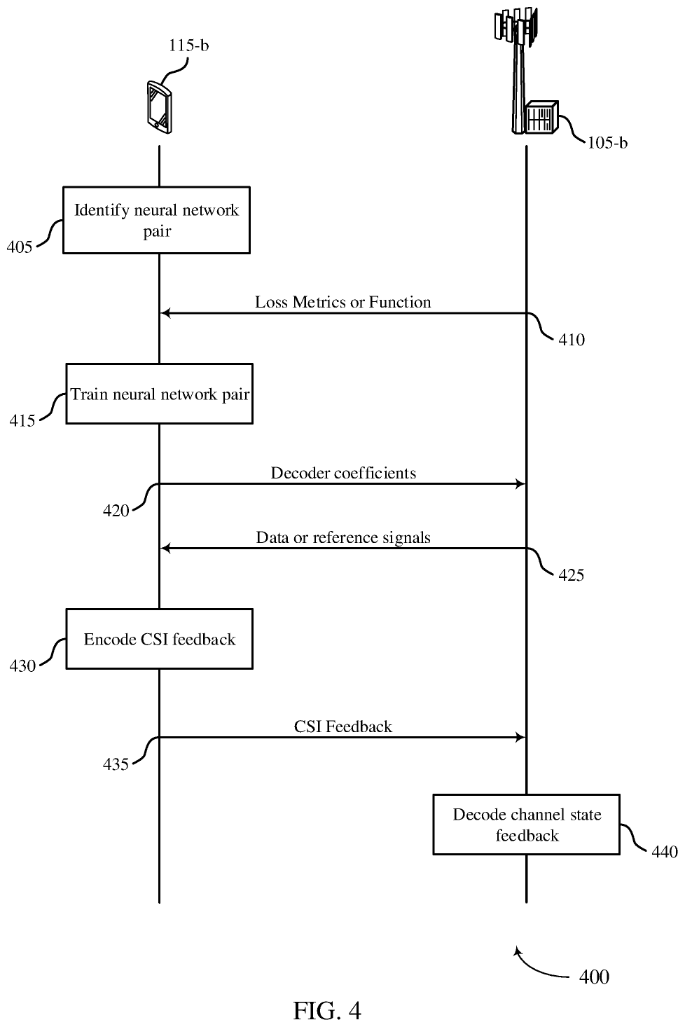

FIG. 4 illustrates an example of a process flow 400 that supports configurable metrics for channel state compression and feedback in accordance with aspects of the present disclosure. The process flow 400 illustrates aspects of techniques performed by a UE 115-b, which may be an example of a UE 115 described with reference to FIGS. 1-3. The process flow 400 also illustrates aspects of techniques performed by a base station 105-b, which may be an example of a base station 105 described with reference to FIGS. 1-3. The process flow 400 may implement aspects of wireless communications system 300. For example, the process flow 400 may support efficient techniques that may allow the UE 115-b to report CSI to the base station 105-b at an appropriate level of accuracy. The UE 115-b may also support a capability to perform channel state compression and feedback differently for different subbands, channel taps, spatial streams, feedback instances, etc.

The level of accuracy may refer to a difference between raw CSI entered (or the actual channel condition measured) as input to an encoder at the UE 115-b and the CSI produced by a decoder at the base station 105-b. For example, a high level of accuracy may indicate a small or no difference between the raw CSI entered (or the actual channel condition measured) as input to the encoder and the CSI produced by the decoder, and a low level of accuracy may indicate a large difference between the raw CSI entered (or the actual channel condition measured) as input to the encoder and the CSI produced by the decoder. In other words, the higher the level of accuracy, the lower the amount of compression, and vice versa. Further, in some cases, when the base station 105-b signals the level of accuracy, the base station 105-b may signal one or more aspects of the CSI for the UE 115-b to focus on when measuring and reporting CSI. The loss function may then prioritize or apply larger weights to the one or more aspects of the CSI indicated by the base station 105-b when training a neural network pair. As such, the UE 115-b may be able to generate and report CSI feedback that aligns with the way the base station 105-b intends to use the CSI feedback. In such cases, the level of accuracy may refer to the prioritization or weights applied to those aspects of CSI that are desirable to the base station 105.

At 405, the UE 115-b may identify a neural network pair including a first neural network at an encoder for encoding channel state feedback and a second neural network at a decoder for decoding the channel state feedback. For example, the base station 105-b may indicate a number of neural network pairs for the UE 115-b to train. In some cases, the UE 115-b may select a neural network pair based on the indication. At 410, the UE 115-b may receive an indication of a level of accuracy for reporting CSI feedback to the base station 105-b (e.g., in an RRC or MAC-CE message). That is, the base station 105-b and the UE 115-b may support differentiated accuracy for CSI feedback. As an example, the UE 115-b may receive an indication of a loss metric or loss function from the base station 105-b, and, at 415, the UE 115-b may train the neural network pair using the loss metric or loss function (e.g., where the loss metric or loss function implicitly indicates the level of accuracy). At 420, the UE 115-b may send the coefficients of the second neural network at the decoder to the base station 105-b based on training the neural network pair.

In some cases, the indicated level of accuracy (or loss metric) may be based on one or more of a subband, spatial layer, or channel tap to which the CSI feedback corresponds. That is, the base station 105-b may indicate loss metrics or loss functions and weights to the UE 115-b for training a neural network pair for different subbands, channel taps, spatial streams, or feedback instances. In such cases, the UE 115-b may receive data from the base station 105-b on the subband or spatial layer or in accordance with the channel tap based on reporting the CSI feedback corresponding to the indicated level of accuracy. Additionally, or alternatively, the indicated level of accuracy may be based on a number of downlink transmissions comprising same data that the UE 115-b failed to decode (e.g., the feedback instance or round of feedback). In such cases, the UE 115-b may receive a retransmission of the same data that the UE failed to decode based on reporting the CSI feedback corresponding to the indicated level of accuracy. For instance, the UE 115-b may report highly accurate CSI feedback if the UE 115-b failed to decode multiple retransmissions of the same data. Accordingly, the base station 105-b may retransmit the same data based on the highly accurate CSI feedback, and the chances that the UE 115-b is able to successfully decode the retransmission of the same data may be high.

In some cases, the UE 115-b may receive an indication to train multiple neural network pairs based on multiple loss metrics or loss functions (e.g., multiple levels of accuracy), and the UE 115-b may train each of the multiple neural network pairs based on a respective level of accuracy of the multiple levels of accuracy. In such cases, the base station 105-b may transmit, and the UE 115-b may receive, an indication of which of the neural network pairs the UE 115-b is to use to report CSI feedback to the base station 105-b. Alternatively, the UE 115-b may autonomously select one of the multiple neural network pairs for reporting the CSI feedback to the base station 105-b. Further, the UE 115-b may receive an indication of a subset of the multiple neural network pairs that the UE 115-b is to train. That is, the base station 105-b may transmit the number of neural network pairs to be trained at the UE 115-b and which of the neural network pairs the UE 115-b is to use for reporting CSI feedback for a specific subband, channel tap, spatial stream, or feedback instance.

At 425, the base station 105-b may transmit downlink data or reference signals (e.g., CSI-RSs) to the UE 115-b, and the UE 115-b may perform channel measurements to generate CSI feedback based on the downlink data or the reference signals received from the base station 105-b. At 430, the UE 115-b may encode the channel state feedback using the first neural network in the neural network pair, and, at 435, the UE 115-b may report the CSI feedback to the base station 105-b (e.g., corresponding to the indicated level of accuracy). In some cases, the UE 115-b may identify a number of bits for reporting the CSI feedback based on the indicated level of accuracy, and the UE 115-b may report the CSI feedback corresponding to the indicated level of accuracy with the identified number of bits. The UE 115-b may receive an indication of the number of bits for reporting the CSI feedback based on the level of accuracy. That is, the base station 105-b may indicate to the UE 115-b a number of bits for quantization of CSI feedback for different subbands, channel taps, spatial streams, or feedback instances. At 440, the base station 105-b may decode the channel state feedback received from the UE 115-b using the second neural network (e.g., based on receiving the decoder coefficients at 420).

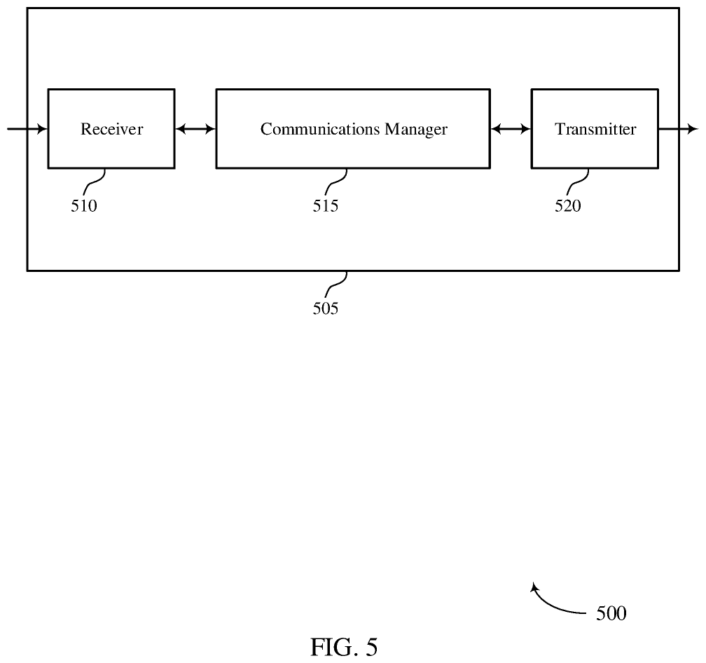

FIG. 5 shows a block diagram 500 of a device 505 that supports configurable metrics for channel state compression and feedback in accordance with aspects of the present disclosure. The device 505 may be an example of aspects of a UE 115 as described herein. The device 505 may include a receiver 510, a communications manager 515, and a transmitter 520. The device 505 may also include a processor. Each of these components may be in communication with one another (e.g., via one or more buses).

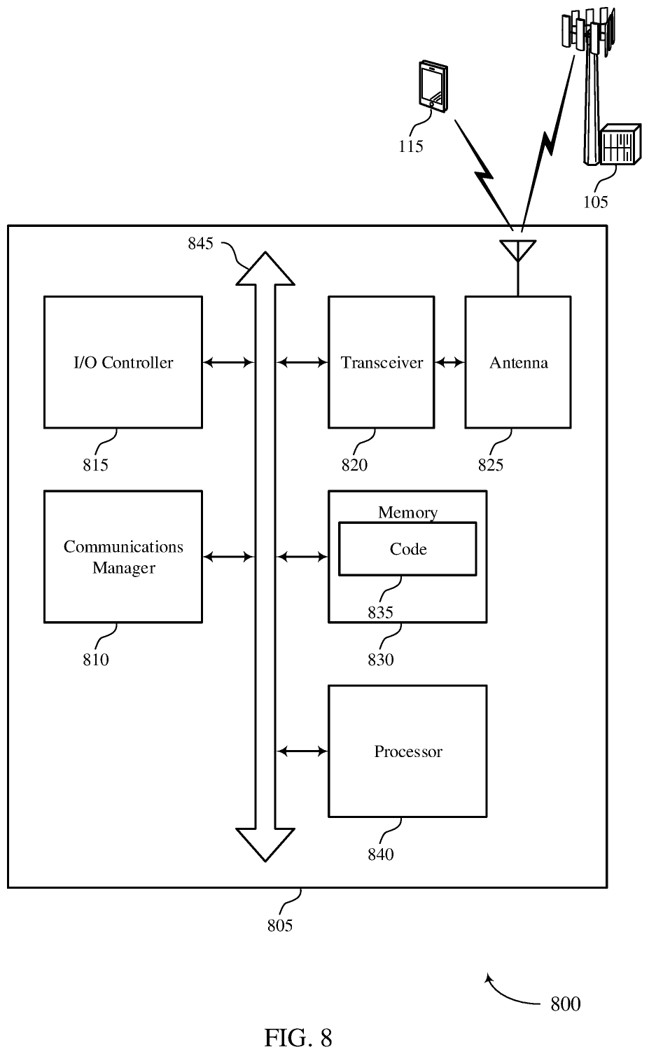

The receiver 510 may receive information such as packets, user data, or control information associated with various information channels (e.g., control channels, data channels, and information related to configurable metrics for channel state compression and feedback, etc.). Information may be passed on to other components of the device 505. The receiver 510 may be an example of aspects of the transceiver 820 described with reference to FIG. 8. The receiver 510 may utilize a single antenna or a set of antennas.

The communications manager 515 may receive, from a base station, an indication of a level of accuracy for reporting channel state feedback to the base station, receive downlink data or reference signals from the base station, and report the channel state feedback to the base station corresponding to the indicated level of accuracy based at least in part on the downlink data or the reference signals. The communications manager 515 may be an example of aspects of the communications manager 810 described herein.

The communications manager 515, or its sub-components, may be implemented in hardware, code (e.g., software or firmware) executed by a processor, or any combination thereof. If implemented in code executed by a processor, the functions of the communications manager 515, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 515, or its sub-components, may be physically located at various positions, including being distributed such that portions of functions are implemented at different physical locations by one or more physical components. In some examples, the communications manager 515, or its sub-components, may be a separate and distinct component in accordance with various aspects of the present disclosure. In some examples, the communications manager 515, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 520 may transmit signals generated by other components of the device 505. In some examples, the transmitter 520 may be collocated with a receiver 510 in a transceiver module. For example, the transmitter 520 may be an example of aspects of the transceiver 820 described with reference to FIG. 8. The transmitter 520 may utilize a single antenna or a set of antennas.

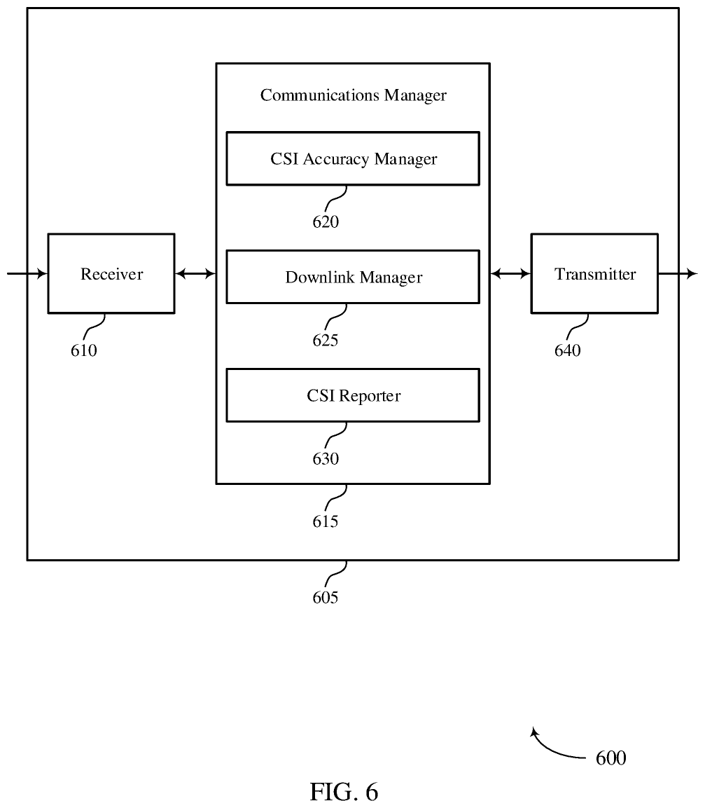

FIG. 6 shows a block diagram 600 of a device 605 that supports configurable metrics for channel state compression and feedback in accordance with aspects of the present disclosure. The device 605 may be an example of aspects of a device 505, or a UE 115 as described herein. The device 605 may include a receiver 610, a communications manager 615, and a transmitter 640. The device 605 may also include a processor. Each of these components may be in communication with one another (e.g., via one or more buses).

The receiver 610 may receive information such as packets, user data, or control information associated with various information channels (e.g., control channels, data channels, and information related to configurable metrics for channel state compression and feedback, etc.). Information may be passed on to other components of the device 605. The receiver 610 may be an example of aspects of the transceiver 820 described with reference to FIG. 8. The receiver 610 may utilize a single antenna or a set of antennas.

The communications manager 615 may be an example of aspects of the communications manager 515 as described herein. The communications manager 615 may include a CSI accuracy manager 620, a downlink manager 625, and a CSI reporter 630. The communications manager 615 may be an example of aspects of the communications manager 810 described herein.

The CSI accuracy manager 620 may receive, from a base station, an indication of a level of accuracy for reporting channel state feedback to the base station. The downlink manager 625 may receive downlink data or reference signals from the base station. The CSI reporter 630 may report the channel state feedback to the base station corresponding to the indicated level of accuracy based on the downlink data or the reference signals.

The transmitter 640 may transmit signals generated by other components of the device 605. In some examples, the transmitter 640 may be collocated with a receiver 610 in a transceiver module. For example, the transmitter 640 may be an example of aspects of the transceiver 820 described with reference to FIG. 8. The transmitter 640 may utilize a single antenna or a set of antennas.

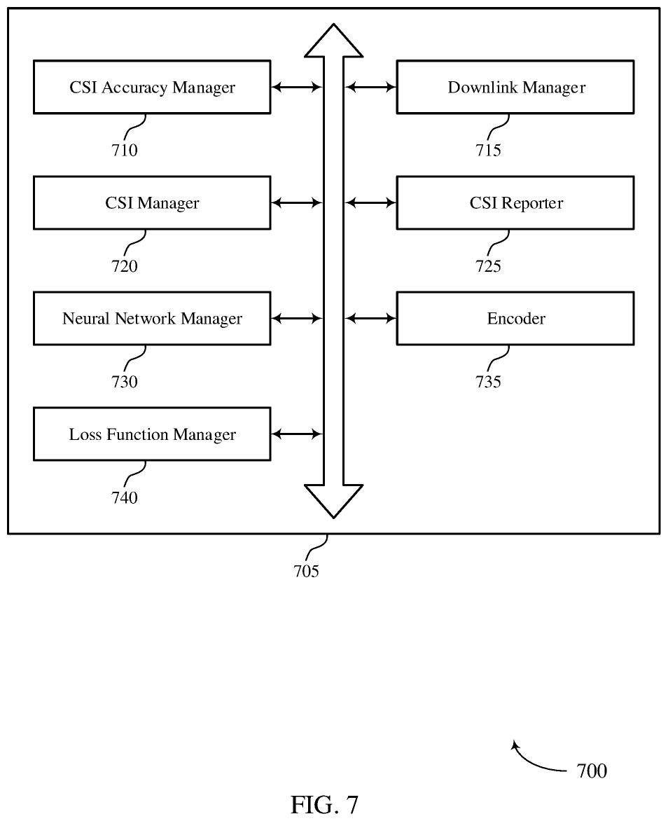

FIG. 7 shows a block diagram 700 of a communications manager 705 that supports configurable metrics for channel state compression and feedback in accordance with aspects of the present disclosure. The communications manager 705 may be an example of aspects of a communications manager 515, a communications manager 615, or a communications manager 810 described herein. The communications manager 705 may include a CSI accuracy manager 710, a downlink manager 715, a CSI manager 720, a CSI reporter 725, a neural network manager 730, an encoder 735, and a loss function manager 740. Each of these modules may communicate, directly or indirectly, with one another (e.g., via one or more buses).

The CSI accuracy manager 710 may receive, from a base station, an indication of a level of accuracy for reporting channel state feedback to the base station. The downlink manager 715 may receive downlink data or reference signals from the base station. The CSI reporter 725 may report the channel state feedback to the base station corresponding to the indicated level of accuracy based on the downlink data or the reference signals.

The loss function manager 740 may receive an indication of a loss function corresponding to the level of accuracy for training a neural network pair, the neural network pair including a first neural network at an encoder for encoding the channel state feedback and a second neural network at a decoder for decoding the channel state feedback. The neural network manager 730 may train the neural network pair using the loss function. The neural network manager 730 may iteratively enter channel state feedback input into the neural network pair and identify channel state feedback output from the neural network pair. The neural network manager 730 may then determine a difference between the channel state feedback input and the channel state feedback output for each iteration using the loss function, where the different includes a loss, and the neural network manager 730 may adjust coefficients of the neural network pair for each iteration to minimize the difference between the channel state feedback input and the channel state feedback output based on the determining.

The encoder 735 may encode the channel state feedback using the first neural network at the encoder based on the training. In some examples, the CSI reporter 725 may report the encoded channel state feedback. In some examples, the neural network manager 730 may send, to the base station, coefficients of the second neural network for decoding the channel state feedback based on the training. In some examples, the neural network manager 730 may receive, from the base station, an indication to train a set of neural network pairs based on a set of levels of accuracy, the set of neural network pairs including the neural network pair. In some examples, the neural network manager 730 may train each of the set of neural network pairs based on a respective level of accuracy of the set of levels of accuracy. In some examples, the neural network manager 730 may receive an indication to use the neural network pair of the set of neural network pairs for reporting the channel state feedback. In some examples, the neural network manager 730 may autonomously select the neural network pair of the set of neural network pairs for reporting the channel state feedback. In some examples, the neural network manager 730 may receive an indication of a subset of the set of neural network pairs for the UE to train.

In some examples, the indicated level of accuracy is based on one or more of a subband, spatial layer, or a channel tap to which the channel state feedback corresponds. In some examples, the downlink manager 715 may receive data from the base station on the subband or spatial layer or in accordance with the channel tap based on reporting the channel state feedback corresponding to the indicated level of accuracy. In some examples, the indicated level of accuracy is based on a number of downlink transmissions comprising same data that the UE failed to decode. In some examples, the downlink manager 715 may receive a retransmission of the same data that the UE failed to decode based on reporting the channel state feedback corresponding to the indicated level of accuracy.

In some examples, the CSI manager 720 may identify a number of bits for reporting the channel state feedback based on the level of accuracy, where the number of bits is directly related to the level of accuracy. In some examples, the CSI reporter 725 may report the channel state feedback corresponding to the indicated level of accuracy with the identified number of bits. In some examples, the CSI manager 720 may receive an indication of the number of bits for reporting the channel state feedback based on the level of accuracy. In some examples, the CSI accuracy manager 710 may receive the indication of the level of accuracy in RRC signaling or in a MAC-CE.

FIG. 8 shows a diagram of a system 800 including a device 805 that supports configurable metrics for channel state compression and feedback in accordance with aspects of the present disclosure. The device 805 may be an example of or include the components of device 505, device 605, or a UE 115 as described herein. The device 805 may include components for bi-directional voice and data communications including components for transmitting and receiving communications, including a communications manager 810, an I/O controller 815, a transceiver 820, an antenna 825, memory 830, and a processor 840. These components may be in electronic communication via one or more buses (e.g., bus 845).

The communications manager 810 may receive, from a base station, an indication of a level of accuracy for reporting channel state feedback to the base station, receive downlink data or reference signals from the base station, and report the channel state feedback to the base station corresponding to the indicated level of accuracy based on the downlink data or the reference signals.

The I/O controller 815 may manage input and output signals for the device 805. The I/O controller 815 may also manage peripherals not integrated into the device 805. In some cases, the I/O controller 815 may represent a physical connection or port to an external peripheral. In some cases, the I/O controller 815 may utilize an operating system such as iOS®, ANDROID®, MS-DOS®, MS-WINDOWS®, OS/2®, UNIX®, LINUX®, or another known operating system. In other cases, the I/O controller 815 may represent or interact with a modem, a keyboard, a mouse, a touchscreen, or a similar device. In some cases, the I/O controller 815 may be implemented as part of a processor. In some cases, a user may interact with the device 805 via the I/O controller 815 or via hardware components controlled by the I/O controller 815.

The transceiver 820 may communicate bi-directionally, via one or more antennas, wired, or wireless links as described above. For example, the transceiver 820 may represent a wireless transceiver and may communicate bi-directionally with another wireless transceiver. The transceiver 820 may also include a modem to modulate the packets and provide the modulated packets to the antennas for transmission, and to demodulate packets received from the antennas.

In some cases, the wireless device may include a single antenna 825. However, in some cases the device may have more than one antenna 825, which may be capable of concurrently transmitting or receiving multiple wireless transmissions.

The memory 830 may include RAM and ROM. The memory 830 may store computer-readable, computer-executable code 835 including instructions that, when executed, cause the processor to perform various functions described herein. In some cases, the memory 830 may contain, among other things, a BIOS which may control basic hardware or software operation such as the interaction with peripheral components or devices.

The processor 840 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In other cases, a memory controller may be integrated into the processor 840. The processor 840 may be configured to execute computer-readable instructions stored in a memory (e.g., the memory 830) to cause the device 805 to perform various functions (e.g., functions or tasks supporting configurable metrics for channel state compression and feedback).

The code 835 may include instructions to implement aspects of the present disclosure, including instructions to support wireless communications. The code 835 may be stored in a non-transitory computer-readable medium such as system memory or other type of memory. In some cases, the code 835 may not be directly executable by the processor 840 but may cause a computer (e.g., when compiled and executed) to perform functions described herein.

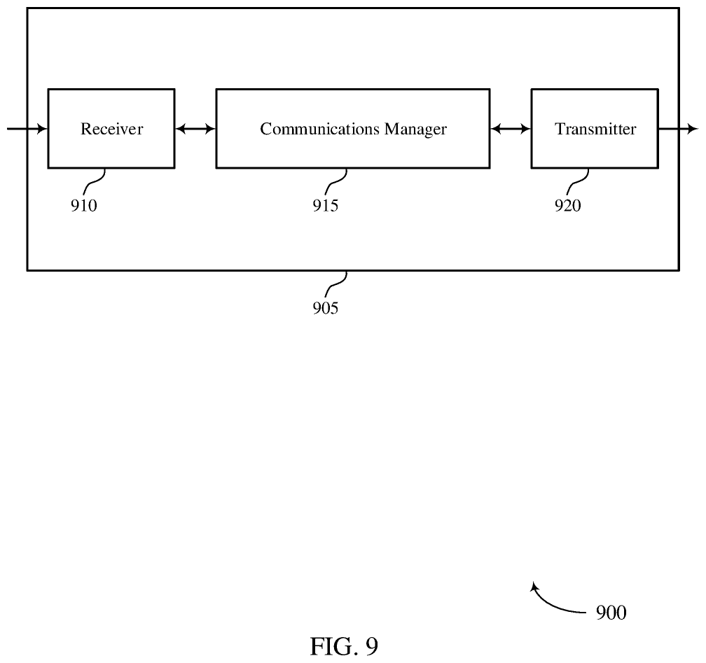

FIG. 9 shows a block diagram 900 of a device 905 that supports configurable metrics for channel state compression and feedback in accordance with aspects of the present disclosure. The device 905 may be an example of aspects of a base station 105 as described herein. The device 905 may include a receiver 910, a communications manager 915, and a transmitter 920. The device 905 may also include a processor. Each of these components may be in communication with one another (e.g., via one or more buses).

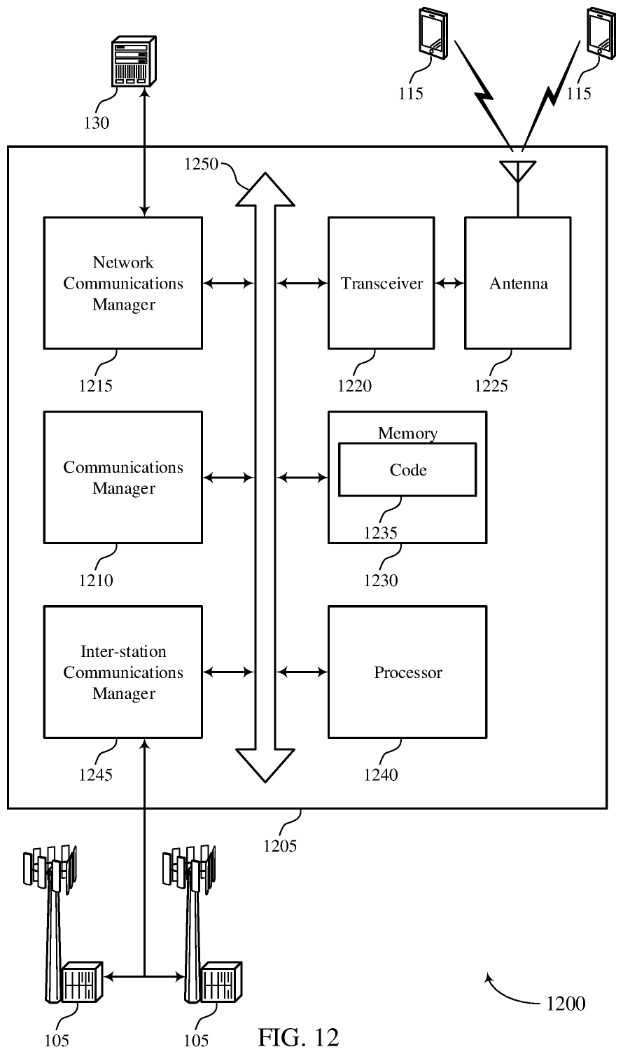

The receiver 910 may receive information such as packets, user data, or control information associated with various information channels (e.g., control channels, data channels, and information related to configurable metrics for channel state compression and feedback, etc.). Information may be passed on to other components of the device 905. The receiver 910 may be an example of aspects of the transceiver 1220 described with reference to FIG. 12. The receiver 910 may utilize a single antenna or a set of antennas.

The communications manager 915 may transmit, to a UE, an indication of a level of accuracy for reporting channel state feedback to the base station, transmit downlink data or reference signals to the UE, and receive channel state feedback from the UE corresponding to the indicated level of accuracy based on transmitting the downlink data or reference signals to the UE. The communications manager 915 may be an example of aspects of the communications manager 1210 described herein.

The communications manager 915, or its sub-components, may be implemented in hardware, code (e.g., software or firmware) executed by a processor, or any combination thereof. If implemented in code executed by a processor, the functions of the communications manager 915, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The communications manager 915, or its sub-components, may be physically located at various positions, including being distributed such that portions of functions are implemented at different physical locations by one or more physical components. In some examples, the communications manager 915, or its sub-components, may be a separate and distinct component in accordance with various aspects of the present disclosure. In some examples, the communications manager 915, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

The transmitter 920 may transmit signals generated by other components of the device 905. In some examples, the transmitter 920 may be collocated with a receiver 910 in a transceiver module. For example, the transmitter 920 may be an example of aspects of the transceiver 1220 described with reference to FIG. 12. The transmitter 920 may utilize a single antenna or a set of antennas.

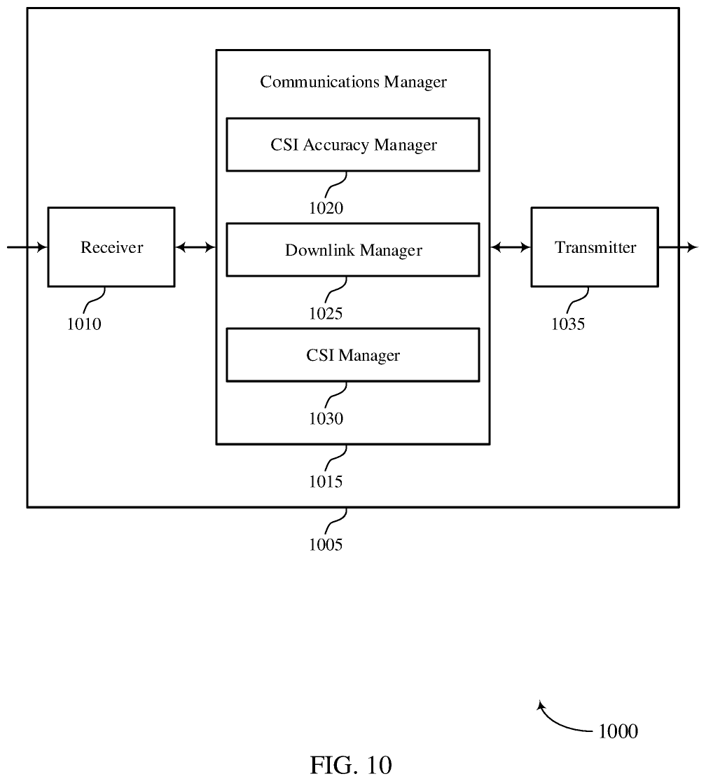

FIG. 10 shows a block diagram 1000 of a device 1005 that supports configurable metrics for channel state compression and feedback in accordance with aspects of the present disclosure. The device 1005 may be an example of aspects of a device 905, or a base station 105 as described herein. The device 1005 may include a receiver 1010, a communications manager 1015, and a transmitter 1035. The device 1005 may also include a processor. Each of these components may be in communication with one another (e.g., via one or more buses).

The receiver 1010 may receive information such as packets, user data, or control information associated with various information channels (e.g., control channels, data channels, and information related to configurable metrics for channel state compression and feedback, etc.). Information may be passed on to other components of the device 1005. The receiver 1010 may be an example of aspects of the transceiver 1220 described with reference to FIG. 12. The receiver 1010 may utilize a single antenna or a set of antennas.

The communications manager 1015 may be an example of aspects of the communications manager 915 as described herein. The communications manager 1015 may include a CSI accuracy manager 1020, a downlink manager 1025, and a CSI manager 1030. The communications manager 1015 may be an example of aspects of the communications manager 1210 described herein.

The CSI accuracy manager 1020 may transmit, to a UE, an indication of a level of accuracy for reporting channel state feedback to the base station. The downlink manager 1025 may transmit downlink data or reference signals to the UE. The CSI manager 1030 may receive channel state feedback from the UE corresponding to the indicated level of accuracy based on transmitting the downlink data or reference signals to the UE.

The transmitter 1035 may transmit signals generated by other components of the device 1005. In some examples, the transmitter 1035 may be collocated with a receiver 1010 in a transceiver module. For example, the transmitter 1035 may be an example of aspects of the transceiver 1220 described with reference to FIG. 12. The transmitter 1035 may utilize a single antenna or a set of antennas.

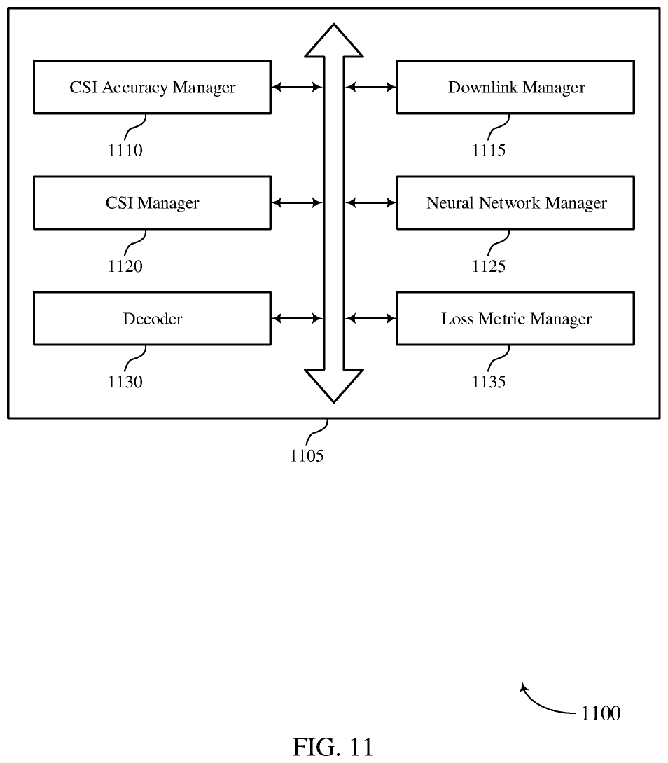

FIG. 11 shows a block diagram 1100 of a communications manager 1105 that supports configurable metrics for channel state compression and feedback in accordance with aspects of the present disclosure. The communications manager 1105 may be an example of aspects of a communications manager 915, a communications manager 1015, or a communications manager 1210 described herein. The communications manager 1105 may include a CSI accuracy manager 1110, a downlink manager 1115, a CSI manager 1120, a neural network manager 1125, a decoder 1130, and a loss metric manager 1135. Each of these modules may communicate, directly or indirectly, with one another (e.g., via one or more buses).

The CSI accuracy manager 1110 may transmit, to a UE, an indication of a level of accuracy for reporting channel state feedback to the base station. The downlink manager 1115 may transmit downlink data or reference signals to the UE. The CSI manager 1120 may receive channel state feedback from the UE corresponding to the indicated level of accuracy based on transmitting the downlink data or reference signals to the UE. The loss metric manager 1135 may transmit an indication of a loss metric or loss function for the UE to use to train a neural network pair for reporting the channel state feedback.

The neural network manager 1125 may receive, from the UE, coefficients of a neural network at a decoder for decoding the channel state feedback from the UE. The decoder 1130 may decode the channel state feedback from the UE using the neural network at the decoder. In some examples, the neural network manager 1125 may transmit an indication for the UE to train a set of neural network pairs based on a set of levels of accuracy, each neural network pair including a first neural network at an encoder for encoding the channel state feedback and a second neural network at a decoder for decoding the channel state feedback. In some examples, the neural network manager 1125 may transmit an indication for the UE to use a neural network pair of the set of neural network pairs for reporting the channel state feedback. In some examples, the neural network manager 1125 may transmit an indication of a subset of the set of neural network pairs for the UE to train.

In some examples, the CSI accuracy manager 1110 may transmit indications of different levels of accuracy for reporting channel state feedback for different subbands, spatial layers, channel taps, or in response to failing to decode different numbers of downlink transmissions including same data. In some examples, the indicated level of accuracy comprises a first level of accuracy for reporting channel state feedback to be used to schedule a first downlink data transmission, and the CSI accuracy manager 1110 may transmit an indication of a second level of accuracy for reporting channel state feedback to be used to schedule a second downlink transmission, the first level of accuracy being different from the second level of accuracy. In some examples, the CSI manager 1120 may transmit an indication of a number of bits for the UE to use to report the channel state feedback based on the level of accuracy, where the number of bits is directly related to the level of accuracy. In some examples, the CSI manager 1120 may receive the channel state feedback corresponding to the indicated level of accuracy with the identified number of bits. In some examples, the CSI accuracy manager 1110 may transmit the indication of the level of accuracy in RRC signaling or in a MAC-CE.

FIG. 12 shows a diagram of a system 1200 including a device 1205 that supports configurable metrics for channel state compression and feedback in accordance with aspects of the present disclosure. The device 1205 may be an example of or include the components of device 905, device 1005, or a base station 105 as described herein. The device 1205 may include components for bi-directional voice and data communications including components for transmitting and receiving communications, including a communications manager 1210, a network communications manager 1215, a transceiver 1220, an antenna 1225, memory 1230, a processor 1240, and an inter-station communications manager 1245. These components may be in electronic communication via one or more buses (e.g., bus 1250).

The communications manager 1210 may transmit, to a UE, an indication of a level of accuracy for reporting channel state feedback to the base station, transmit downlink data or reference signals to the UE, and receive channel state feedback from the UE corresponding to the indicated level of accuracy based on transmitting the downlink data or reference signals to the UE.

The network communications manager 1215 may manage communications with the core network (e.g., via one or more wired backhaul links). For example, the network communications manager 1215 may manage the transfer of data communications for client devices, such as one or more UEs 115.

The transceiver 1220 may communicate bi-directionally, via one or more antennas, wired, or wireless links as described above. For example, the transceiver 1220 may represent a wireless transceiver and may communicate bi-directionally with another wireless transceiver. The transceiver 1220 may also include a modem to modulate the packets and provide the modulated packets to the antennas for transmission, and to demodulate packets received from the antennas.

In some cases, the wireless device may include a single antenna 1225. However, in some cases the device may have more than one antenna 1225, which may be capable of concurrently transmitting or receiving multiple wireless transmissions.

The memory 1230 may include RAM, ROM, or a combination thereof. The memory 1230 may store computer-readable code 1235 including instructions that, when executed by a processor (e.g., the processor 1240) cause the device to perform various functions described herein. In some cases, the memory 1230 may contain, among other things, a BIOS which may control basic hardware or software operation such as the interaction with peripheral components or devices.

The processor 1240 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some cases, a memory controller may be integrated into processor 1240. The processor 1240 may be configured to execute computer-readable instructions stored in a memory (e.g., the memory 1230) to cause the device 1205 to perform various functions (e.g., functions or tasks supporting configurable metrics for channel state compression and feedback).

The inter-station communications manager 1245 may manage communications with other base station 105, and may include a controller or scheduler for controlling communications with UEs 115 in cooperation with other base stations 105. For example, the inter-station communications manager 1245 may coordinate scheduling for transmissions to UEs 115 for various interference mitigation techniques such as beamforming or joint transmission. In some examples, the inter-station communications manager 1245 may provide an X2 interface within an LTE/LTE-A wireless communication network technology to provide communication between base stations 105.

The code 1235 may include instructions to implement aspects of the present disclosure, including instructions to support wireless communications. The code 1235 may be stored in a non-transitory computer-readable medium such as system memory or other type of memory. In some cases, the code 1235 may not be directly executable by the processor 1240 but may cause a computer (e.g., when compiled and executed) to perform functions described herein.

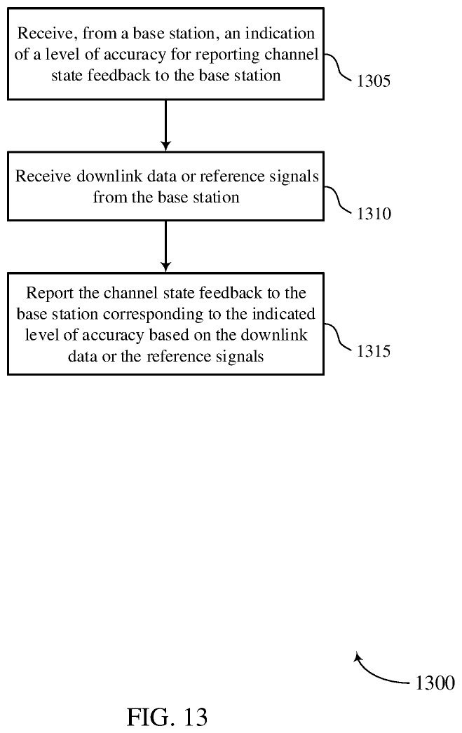

FIG. 13 shows a flowchart illustrating a method 1300 that supports configurable metrics for channel state compression and feedback in accordance with aspects of the present disclosure. The operations of method 1300 may be implemented by a UE 115 or its components as described herein. For example, the operations of method 1300 may be performed by a communications manager as described with reference to FIGS. 5 through 8. In some examples, a UE may execute a set of instructions to control the functional elements of the UE to perform the functions described below. Additionally, or alternatively, a UE may perform aspects of the functions described below using special-purpose hardware.

At 1305, the UE may receive, from a base station, an indication of a level of accuracy for reporting channel state feedback to the base station. The operations of 1305 may be performed according to the methods described herein. In some examples, aspects of the operations of 1305 may be performed by a CSI accuracy manager as described with reference to FIGS. 6 and 7.

At 1310, the UE may receive downlink data or reference signals from the base station. The operations of 1310 may be performed according to the methods described herein. In some examples, aspects of the operations of 1310 may be performed by a downlink manager as described with reference to FIGS. 6 and 7.

At 1315, the UE may report the channel state feedback to the base station corresponding to the indicated level of accuracy based on the downlink data or the reference signals. The operations of 1315 may be performed according to the methods described herein. In some examples, aspects of the operations of 1315 may be performed by a CSI reporter as described with reference to FIGS. 6 and 7.

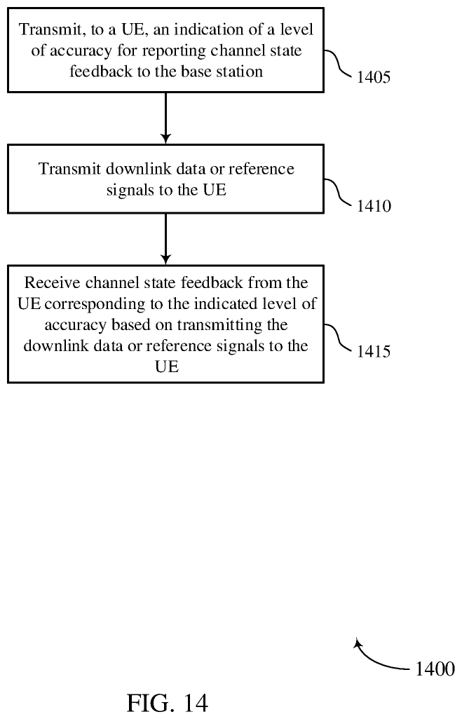

FIG. 14 shows a flowchart illustrating a method 1400 that supports configurable metrics for channel state compression and feedback in accordance with aspects of the present disclosure. The operations of method 1400 may be implemented by a base station 105 or its components as described herein. For example, the operations of method 1400 may be performed by a communications manager as described with reference to FIGS. 9 through 12. In some examples, a base station may execute a set of instructions to control the functional elements of the base station to perform the functions described below. Additionally, or alternatively, a base station may perform aspects of the functions described below using special-purpose hardware.

At 1405, the base station may transmit, to a UE, an indication of a level of accuracy for reporting channel state feedback to the base station. The operations of 1405 may be performed according to the methods described herein. In some examples, aspects of the operations of 1405 may be performed by a CSI accuracy manager as described with reference to FIGS. 10 and 11.

At 1410, the base station may transmit downlink data or reference signals to the UE. The operations of 1410 may be performed according to the methods described herein. In some examples, aspects of the operations of 1410 may be performed by a downlink manager as described with reference to FIGS. 10 and 11.

At 1415, the base station may receive channel state feedback from the UE corresponding to the indicated level of accuracy based on transmitting the downlink data or reference signals to the UE. The operations of 1415 may be performed according to the methods described herein. In some examples, aspects of the operations of 1415 may be performed by a CSI manager as described with reference to FIGS. 10 and 11.

The following provides an overview of examples of the present disclosure:

Example 1: A method for wireless communications at a UE, comprising: receiving, from a base station, an indication of a level of accuracy for reporting channel state feedback to the base station; receiving downlink data or reference signals from the base station; and reporting the channel state feedback to the base station corresponding to the indicated level of accuracy based at least in part on the downlink data or the reference signals.

Example 2: The method of example 1, wherein receiving the indication of the level of accuracy for reporting channel state feedback comprises: receiving an indication of a loss function corresponding to the level of accuracy for training a neural network pair, the neural network pair comprising a first neural network at an encoder for encoding the channel state feedback and a second neural network at a decoder for decoding the channel state feedback, the method further comprising: training the neural network pair using the loss function.

Example 3: The method of any one of examples 1 or 2, wherein training the neural network pair using the loss function comprises: iteratively entering channel state feedback input into the neural network pair and identifying channel state feedback output from the neural network pair; determining a difference between the channel state feedback input and the channel state feedback output for each iteration using the loss function, wherein the difference comprises a loss; and adjusting coefficients of the neural network pair for each iteration to minimize the difference between the channel state feedback input and the channel state feedback output based at least in part on the determining.

Example 4: The method of any one of examples 1 through 3, wherein reporting the channel state feedback corresponding to the indicated level of accuracy comprises: encoding the channel state feedback using the first neural network at the encoder based at least in part on the training; and reporting the encoded channel state feedback.

Example 5: The method of any one of examples 1 through 4, further comprising: sending, to the base station, coefficients of the second neural network for decoding the channel state feedback based at least in part on the training.

Example 6: The method of any one of examples 1 through 5, further comprising: receiving, from the base station, an indication to train a plurality of neural network pairs based at least in part on a plurality of levels of accuracy, the plurality of neural network pairs comprising the neural network pair; and training each of the plurality of neural network pairs based at least in part on a respective level of accuracy of the plurality of levels of accuracy.

Example 7: The method of any one of examples 1 through 6, wherein receiving the indication of the level of accuracy comprises: receiving an indication to use the neural network pair of the plurality of neural network pairs for reporting the channel state feedback.

Example 8: The method of any one of examples 1 through 7, further comprising: autonomously selecting the neural network pair of the plurality of neural network pairs for reporting the channel state feedback.

Example 9: The method of any one of examples 1 through 8, further comprising: receiving an indication of a subset of the plurality of neural network pairs for the UE to train.

Example 10: The method of any one of examples 1 through 9, wherein the indicated level of accuracy is based at least in part on one or more of a subband, spatial layer, or channel tap to which the channel state feedback corresponds, the method further comprising: receiving data from the base station on the subband or spatial layer or in accordance with the channel tap based at least in part on reporting the channel state feedback corresponding to the indicated level of accuracy.

Example 11: The method of any one of examples 1 through 10, wherein the indicated level of accuracy is based at least in part on a number of downlink transmissions comprising same data that the UE failed to decode, the method further comprising: receiving a retransmission of the same data that the UE failed to decode based at least in part on reporting the channel state feedback corresponding to the indicated level of accuracy.

Example 12: The method of any one of examples 1 through 11, further comprising: identifying a number of bits for reporting the channel state feedback based at least in part on the level of accuracy, wherein the number of bits is directly related to the level of accuracy; and reporting the channel state feedback corresponding to the indicated level of accuracy with the identified number of bits.

Example 13: The method of any one of examples 1 through 12, further comprising: receiving an indication of the number of bits for reporting the channel state feedback based at least in part on the level of accuracy.

Example 14: The method of any one of examples 1 through 13, wherein receiving the indication of the level of accuracy comprises: receiving the indication of the level of accuracy in RRC signaling or in a MAC-CE.

Example 15: A method for wireless communications at a base station, comprising: transmitting, to a user equipment (UE), an indication of a level of accuracy for reporting channel state feedback to the base station; transmitting downlink data or reference signals to the UE; and receiving channel state feedback from the UE corresponding to the indicated level of accuracy based at least in part on transmitting the downlink data or reference signals to the UE.

Example 16: The method of example 15, wherein transmitting the indication of the level of accuracy for reporting channel state feedback comprises: transmitting an indication of a loss function for the UE to use to train a neural network pair for reporting the channel state feedback.

Example 17: The method of any one of examples 15 or 16, further comprising: receiving, from the UE, coefficients of a neural network at a decoder for decoding the channel state feedback from the UE; and decoding the channel state feedback from the UE using the neural network at the decoder.

Example 18: The method of any one of examples 15 through 17, further comprising: transmitting an indication for the UE to train a plurality of neural network pairs based at least in part on a plurality of levels of accuracy, each neural network pair comprising a first neural network at an encoder for encoding the channel state feedback and a second neural network at a decoder for decoding the channel state feedback.

Example 19: The method of any one of examples 15 through 18, further comprising: transmitting an indication for the UE to use a neural network pair of the plurality of neural network pairs for reporting the channel state feedback.

Example 20: The method of any one of examples 15 through 19, further comprising: transmitting an indication of a subset of the plurality of neural network pairs for the UE to train.

Example 21: The method of any one of examples 15 through 20, wherein transmitting the indication of the level of accuracy for reporting channel state feedback comprises: transmitting indications of different levels of accuracy for reporting channel state feedback for different subbands, spatial layers, channel taps, or in response to failing to decode different numbers of downlink transmissions comprising same data.

Example 22: The method of any one of examples 15 through 21, wherein the indicated level of accuracy comprises a first level of accuracy for reporting channel state feedback to be used to schedule a first downlink data transmission, the method further comprising: transmitting an indication of a second level of accuracy for reporting channel state feedback to be used to schedule a second downlink transmission, the first level of accuracy being different from the second level of accuracy.

Example 23: The method of any one of examples 15 through 22, further comprising: transmitting an indication of a number of bits for the UE to use to report the channel state feedback based at least in part on the level of accuracy, wherein the number of bits is directly related to the level of accuracy; and receiving the channel state feedback corresponding to the indicated level of accuracy with the identified number of bits.

Example 24: The method of any one of examples 15 through 23, wherein transmitting the indication of the level of accuracy comprises: transmitting the indication of the level of accuracy in RRC signaling or in a MAC-CE.

Example 25: An apparatus for wireless communication comprising at least one means for performing a method of any one of examples 1 through 14.

Example 26: An apparatus for wireless communication comprising a processor and memory coupled to the processor. The processor and memory may be configured to cause the apparatus to perform a method of any one of examples 1 through 14.

Example 27: A non-transitory computer-readable medium storing code for wireless communication comprising a processor, memory coupled to the processor, and instructions stored in the memory and executable by the processor to cause the apparatus to perform a method of any one of examples 1 through 14.

Example 28: An apparatus for wireless communication comprising at least one means for performing a method of any one of examples 15 through 24.

Example 29: An apparatus for wireless communication comprising a processor and memory coupled to the processor. The processor and memory may be configured to cause the apparatus to perform a method of any one of examples 15 through 24.

Example 30: A non-transitory computer-readable medium storing code for wireless communication comprising a processor, memory coupled to the processor, and instructions stored in the memory and executable by the processor to cause the apparatus to perform a method of any one of examples 15 through 24.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special purpose computer. By way of example, and not limitation, non-transitory computer-readable media may include random-access memory (RAM), read-only memory (ROM), electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. A method for wireless communication at a user equipment (UE), comprising:
receiving, from a base station, an indication of a level of accuracy for reporting channel state feedback to the base station;
receiving downlink data or reference signals from the base station; and
reporting the channel state feedback to the base station corresponding to the level of accuracy based at least in part on the downlink data or the reference signals.

2. The method of claim 1, wherein receiving the indication of the level of accuracy for reporting channel state feedback comprises:
receiving an indication of a loss function corresponding to the level of accuracy for training a neural network pair, the neural network pair comprising a first neural network at an encoder for encoding the channel state feedback and a second neural network at a decoder for decoding the channel state feedback, the method further comprising:
training the neural network pair using the loss function.

3. The method of claim 2, wherein training the neural network pair using the loss function comprises:
iteratively entering channel state feedback input into the neural network pair and identifying channel state feedback output from the neural network pair;
determining a difference between the channel state feedback input and the channel state feedback output for each iteration using the loss function, wherein the difference comprises a loss; and
adjusting coefficients of the neural network pair for each iteration to minimize the difference between the channel state feedback input and the channel state feedback output based at least in part on the determining.

4. The method of claim 2, wherein reporting the channel state feedback corresponding to the level of accuracy comprises:
encoding the channel state feedback using the first neural network at the encoder based at least in part on the training; and
reporting the encoded channel state feedback.

5. The method of claim 2, further comprising:
sending, to the base station, coefficients of the second neural network for decoding the channel state feedback based at least in part on the training.

6. The method of claim 2, further comprising:
receiving, from the base station, an indication to train a plurality of neural network pairs based at least in part on a plurality of levels of accuracy, the plurality of neural network pairs comprising the neural network pair; and.
training each of the plurality of neural network pairs based at least in part on a respective level of accuracy of the plurality of levels of accuracy.

7-9. (canceled)

10. The method of claim 1, wherein the level of accuracy is based at least in part on one or more of a subband, spatial layer, or channel tap to which the channel state feedback corresponds, the method further comprising:
receiving data from the base station on the subband or spatial layer or in accordance with the channel tap based at least in part on reporting the channel state feedback corresponding to the level of accuracy.

11. The method of claim 1, wherein the level of accuracy is based at least in part on a number of downlink transmissions comprising same data that the UE failed to decode, the method further comprising:
receiving a retransmission of the same data that the UE failed to decode based at least in part on reporting the channel state feedback corresponding to the level of accuracy.

12. The method of claim 1, further comprising:
identifying a number of bits for reporting the channel state feedback based at least in part on the level of accuracy, wherein the number of bits is directly related to the level of accuracy; and
reporting the channel state feedback corresponding to the level of accuracy with the identified number of bits.

13. (canceled)

14. The method of claim 1, wherein receiving the indication of the level of accuracy comprises:
receiving the indication of the level of accuracy in radio resource control (RRC) signaling or in a media access control (MAC) control element (MAC-CE).

15. A method for wireless communication at a base station, comprising:
transmitting, to a user equipment (UE), an indication of a level of accuracy for reporting channel state feedback to the base station;
transmitting downlink data or reference signals to the UE; and
receiving channel state feedback from the UE corresponding to the level of accuracy based at least in part on transmitting the downlink data or reference signals to the UE.

16. The method of claim 15, wherein transmitting the indication of the level of accuracy for reporting channel state feedback comprises:
transmitting an indication of a loss function for the UE to use to train a neural network pair for reporting the channel state feedback.

17. The method of claim 15, further comprising:
receiving, from the UE, coefficients for a neural network at a decoder for decoding the channel state feedback from the UE; and
decoding the channel state feedback from the UE using the neural network at the decoder.

18-24. (canceled)

25. An apparatus for wireless communication at a user equipment (UE), comprising:
means for receiving, from a base station, an indication of a level of accuracy for reporting channel state feedback to the base station;
means for receiving downlink data or reference signals from the base station; and
means for reporting the channel state feedback to the base station corresponding to the level of accuracy based at least in part on the downlink data or the reference signals.

26-32. (canceled)

33. An apparatus for wireless communication at a user equipment (UE), comprising:
a processor,
memory coupled with the processor; and
instructions stored in the memory and executable by the processor to cause the apparatus to:
receive, from a base station, an indication of a level of accuracy for reporting channel state feedback to the base station;
receive downlink data or reference signals from the base station; and
report the channel state feedback to the base station corresponding to the level of accuracy based at least in part on the downlink data or the reference signals.

34-36. (canceled)

37. The apparatus of claim 33, wherein the instructions to receive the indication of the level of accuracy for reporting channel state feedback are executable by the processor to cause the apparatus to:
receive an indication of a loss function corresponding to the level of accuracy for training a neural network pair, the neural network pair comprising a first neural network at an encoder for encoding the channel state feedback and a second neural network at a decoder for decoding the channel state feedback, and wherein the instructions are further executable by the processor to cause the apparatus to:
train the neural network pair using the loss function.

38. The apparatus of claim 37, wherein the instructions to train the neural network pair using the loss function are executable by the processor to cause the apparatus to:
iteratively enter channel state feedback input into the neural network pair and identify channel state feedback output from the neural network pair;
determine a difference between the channel state feedback input and the channel state feedback output for each iteration using the loss function, wherein the difference comprises a loss; and
adjust coefficients of the neural network pair for each iteration to minimize the difference between the channel state feedback input and the channel state feedback output based at least in part on a determination of the difference.

39. The apparatus of claim 37, wherein the instructions to report the channel state feedback corresponding to the level of accuracy are executable by the processor to cause the apparatus to:
encode the channel state feedback using the first neural network at the encoder based at least in part on a training of the neural network pair; and
report the encoded channel state feedback:

40. The apparatus of claim 37, wherein the instructions are further executable by the processor to cause the apparatus to:
send, to the base station, coefficients of the second neural network for decoding the channel state feedback based at least in part on a training of the neural network pair.

41. The apparatus of claim 37, wherein the instructions are further executable by the processor to cause the apparatus to:
receive, from the base station, an indication to train a plurality of neural network pairs based at least in part on a plurality of levels of accuracy, the plurality of neural network pairs comprising the neural network pair; and
train each of the plurality of neural network pairs based at least in part on a respective level of accuracy of the plurality of levels of accuracy.

42. The apparatus of claim 41, wherein the instructions to receive the indication of the level of accuracy are executable by the processor to cause the apparatus to:
receive an indication to use the neural network pair of the plurality of neural network pairs for reporting the channel state feedback.

43. The apparatus of claim 41, wherein the instructions are further executable by the processor to cause the apparatus to:
autonomously select the neural network pair of the plurality of neural nets network pairs for reporting the channel state feedback.

44. The apparatus of claim 41, wherein the instructions are further executable by the processor to cause the apparatus to:
receive an indication of a subset of the plurality of neural network pairs for the UE to train.

45. The apparatus of claim 33, wherein the level of accuracy is based at least in part on one or more of a subband, spatial layer, or channel tap to which the channel state feedback corresponds, and wherein the instructions are further executable by the processor to cause the apparatus to:
receive data from the base station on the subband or spatial layer or in accordance with the channel tap based at least in part on a reporting of the channel state feedback corresponding to the level of accuracy.

46. The apparatus of claim 33, wherein the level of accuracy is based at least in part on a number of downlink transmissions comprising same data that the UE failed to decode, and wherein the instructions are further executable by the processor o cause the apparatus to:
receive a retransmission of the same data that the UE failed to decode based at least in part on a reporting of the channel state feedback corresponding to the level of accuracy.

47. The apparatus of claim 33, wherein the instructions are further executable by the processor to cause the apparatus to:
identify a number of bits for reporting the channel state feedback based at least in part on the level of accuracy, wherein the number of bits is directly related to the level of accuracy; and
report, the channel state feedback corresponding to the level of accuracy with the identified number of bits.

48. The apparatus of claim 47, wherein the instructions are further executable by the processor to cause the apparatus to:
receive an indication of the number of bits for reporting the channel state feedback based at least in part on the level of accuracy.

49. The apparatus of claim 33, wherein the instructions to receive the indication of the level of accuracy are executable by the processor to cause the apparatus to:
receive the indication of the level of accuracy in radio resource control (RRC) signaling or in a media access control (MAC) control element (MAC-CE).

50. An apparatus for wireless communication at a base station, comprising:
a processor,
memory coupled with the processor; and
instructions stored in the memory and executable by the processor to cause the apparatus to:
transmit, to a user equipment (UE), an indication of a level of accuracy for reporting channel state feedback to the base station;
transmit downlink data or reference signals to the UE; and
receive channel state feedback from the UE corresponding to the level of accuracy based at least in part on a transmission of the downlink data or reference signals to the UE.

51. The apparatus of claim 50, wherein the instructions to transmit the indication of the level of accuracy for reporting channel state feedback are executable by the processor to cause the apparatus to:
transmit an indication of a loss function for the UE to use to train a neural network pair for reporting the channel state feedback.

52. The apparatus of claim 50, wherein the instructions are further executable by the processor to cause the apparatus to:
receive, from the UE, coefficients for a neural network at a decoder for decoding the channel state feedback from the UE; and
decode the channel state feedback from the UE using the neural network at the decoder.

53. The apparatus of claim 50, wherein the instructions are further executable by the processor to cause the apparatus to:
transmit an indication for the UE to train a plurality of neural network pairs based at least in part on a plurality of levels of accuracy, each neural network pair comprising a first neural network at an encoder for encoding the channel state feedback and a second neural network at a decoder for decoding the channel state feedback.

54. The apparatus of claim 50, wherein the instructions to transmit the indication of the level of accuracy for reporting channel state feedback are executable by the processor to cause the apparatus to:
transmit indications of different levels of accuracy for reporting channel state feedback for different subbands, spatial layers, channel taps, or in response to failing to decode different numbers of downlink transmissions comprising same data.

55. The apparatus of claim 50, wherein the level of accuracy comprises a first level of accuracy for reporting channel state feedback to be used to schedule a first downlink data transmission, and wherein the instructions are further executable by the processor to cause the apparatus to:
transmit an indication of a second level of accuracy for reporting channel state feedback to be used to schedule a second downlink transmission, the first level of accuracy being different from the second level of accuracy.

56. The apparatus of claim 50, wherein the instructions are further executable by the processor to cause the apparatus to:
transmit an indication of a number of bits for the UE to use to report the channel state feedback based at least in part on the level of accuracy, wherein the number of bits is directly related to the level of accuracy; and
receive the channel state feedback corresponding to the level of accuracy with the number of bits.
